(19) United States
(12) Patent Application Publication
(10) Pub. No.: US 2006/0013475 A1
(43) Pub. Date: Jan. 19, 2006

(54) Computer vision system and method employing illumination invariant neural networks

(75) Inventors: Vasanth Philomin, Stolberg (DE); Srinivas Gutta, Eindhoven (NL); Miroslav Trajkovic, Coram, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V.

(21) Appl. No.: 10/538,206

(22) PCT Filed: Dec. 8, 2003
(86) PCT No.: PCT/IB03/05747

§ 371 Date: Jun. 9, 2005

(30) Foreign Application Priority Data
Dec. 11, 2002 (US) 60432540

(51) Int. Cl. G06K 9/62

(52) U.S. Cl. 382/156

(57) ABSTRACT

Objects are classified using a normalized cross correlation (NCC) measure to compare two images acquired under non-uniform illumination conditions. An input pattern is classified to assign a tentative classification label and value. The input pattern is assigned to an output node in the radial basis function network having the largest classification value. If the input pattern and an image associated with the node, referred to as a node image, both have uniform illumination, then the node image is accepted and the probability is set above a user specified threshold. If the test image or the node image are not uniform, then the node image is not accepted and the classification value is kept as the value assigned by the classifier. If both the test image and the node image are not uniform, then an NCC measure is used and the classification value is set as the NCC value.

The present invention relates to computer vision systems, and more particularly, to the classification of objects in image data using Radial Basis Function Networks (RBFNs).

Computer vision techniques are frequently used to automatically detect or classify objects or events in images. The ability to differentiate among objects is an important task for the efficient functioning of many computer vision systems. For example, in certain applications it is important for a computer vision system to distinguish between animate objects, such as people and pets, and inanimate objects, such as furniture and doors. Pattern recognition techniques, for example, are often applied to images to determine a likelihood (probability) that a given object or class of objects appears in the image. For a detailed discussion of pattern recognition or classification techniques, see, for example, R. O. Duda and P. Hart, Pattern Recognition and Scene Analysis, Wiley, New York (1973); R. T. Chin and C. R. Dyer, “Model-Based Recognition in Robot Vision,” ACM Computing Surveys, 18(1), 67-108 (March, 1986); or P. J. Besl and R. C. Jain, “Three-Dimensional Object Recognition,” Computing Surveys, 17(1), 75-145 (March, 1985), each incorporated by reference herein.

Appearance based techniques have been extensively used for object recognition because of their inherent ability to exploit image based information. Appearance based techniques attempt to recognize objects by finding the best match between a two-dimensional image representation of the object appearance and stored prototypes. Generally, appearance based methods use a lower dimensional subspace of the higher dimensional representation for the purpose of comparison. U.S. patent application Ser. No. 09/794,443, filed Feb. 27, 2001, entitled “Classification of Objects Through Model Ensembles,” for example, discloses an object classification engine that distinguishes between people and pets in a residential home environment. Initially, speed and aspect ratio information are used to filter out invalid moving objects, such as furniture. Thereafter, gradient images are extracted from the remaining objects and applied to a radial basis function network to classify moving objects as people or pets.

Generally, a radial basis function network involves three different layers. An input layer is made up of source nodes, often referred to as input nodes. The second layer is a hidden layer, comprised of hidden nodes, whose function is to cluster the data and, generally, to reduce its dimensionality to a limited degree. The output layer supplies the response of the network to the activation patterns applied to the input layer. The transformation from the input space to the hidden-unit space is non-linear, whereas the transformation from the hidden-unit space to the output space is linear. A radial basis function network is initially trained using example images of objects to be recognized. When presented with image data to be recognized, the radial basis function network computes the distance between the input data and each hidden node. The computed distance provides a score that can be used to classify an object.

If the training images and the test images to be classified are not acquired under similar illumination conditions, the comparison of the input image with each hidden node will be erroneous, thereby leading to poor classification or recognition. A need therefore exists for an improved method and apparatus for comparing images acquired under non-uniform illumination conditions.

Generally, a method and apparatus are disclosed for classifying objects under varying illumination conditions. The disclosed classifier uses an improved neural network, such as a radial basis function network, to classify objects. The classifier employs a normalized cross correlation (NCC) measure to compare two images acquired under non-uniform illumination conditions.

An input pattern to be classified is initially processed using conventional classification techniques to assign a tentative classification label and classification value (sometimes referred to as a “probability value”) to the input pattern. Generally, an input pattern is assigned to an output node in the radial basis function network having the largest classification value. Thereafter, according to one aspect of the invention, it is determined whether the input pattern and the image associated with the node to which the input pattern was classified, referred to as a node image, have uniform illumination.

If the test image and the node image are both uniform, then the node image is accepted and the probability is set to a value above a user specified threshold. If the test image is uniform and the node image is not uniform (or vice versa), then the image is not accepted and the classification value is kept as the same value as assigned by the classifier. Finally, if both the test image and the node image are not uniform, then a normalized cross correlation measure is used and the classification value is set as the NCC value.

A more complete understanding of the present invention, as well as further features and advantages of the present invention, will be obtained by reference to the following detailed description and drawings.

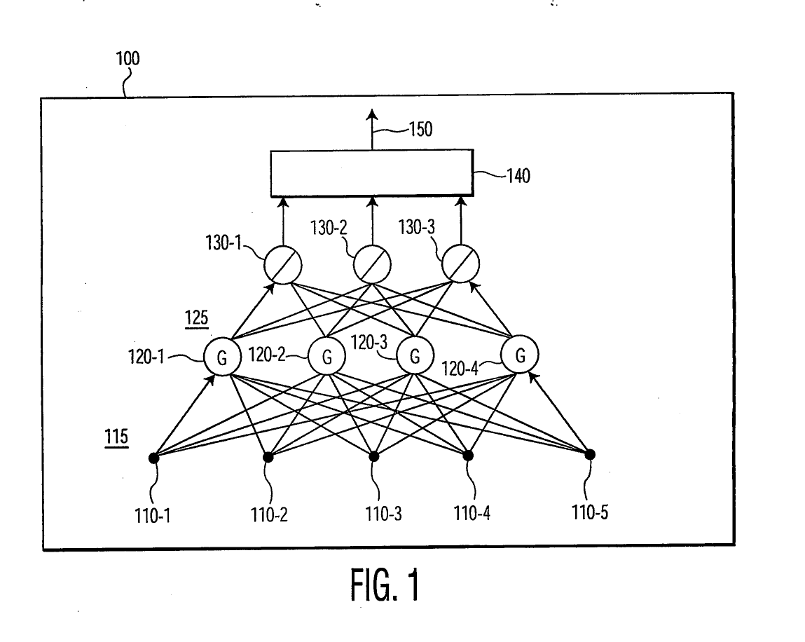

FIG. 1 illustrates an exemplary prior art classifier that uses Radial Basis Functions (RBFs);

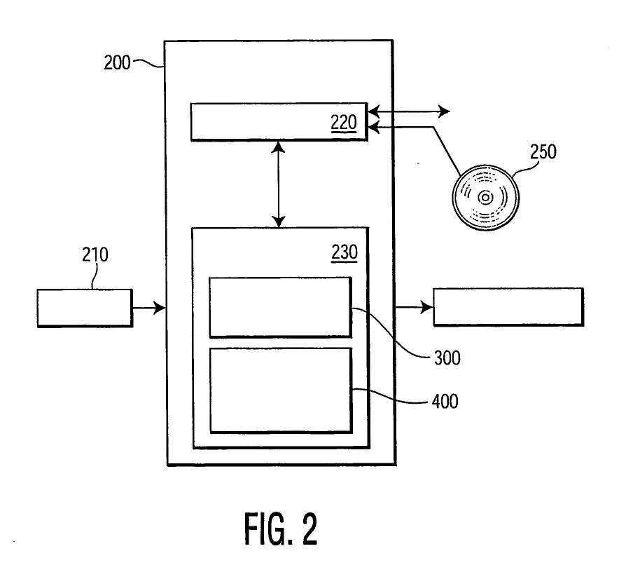

FIG. 2 is a schematic block diagram of an illustrative pattern classification system in accordance with the present invention;

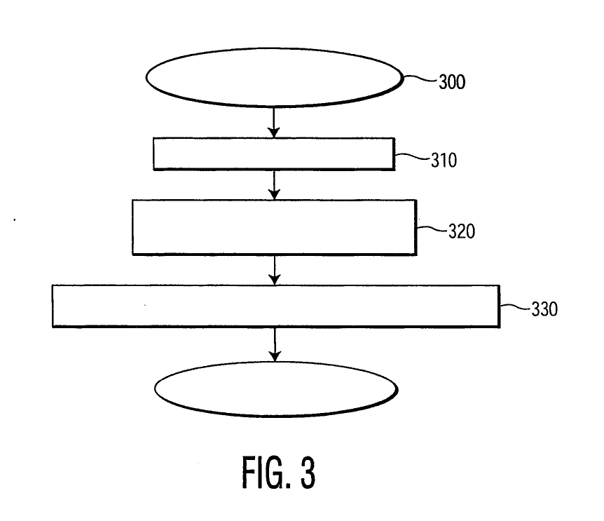

FIG. 3 is a flow chart describing an exemplary RBFN training process for training the pattern classification system of FIG. 2; and

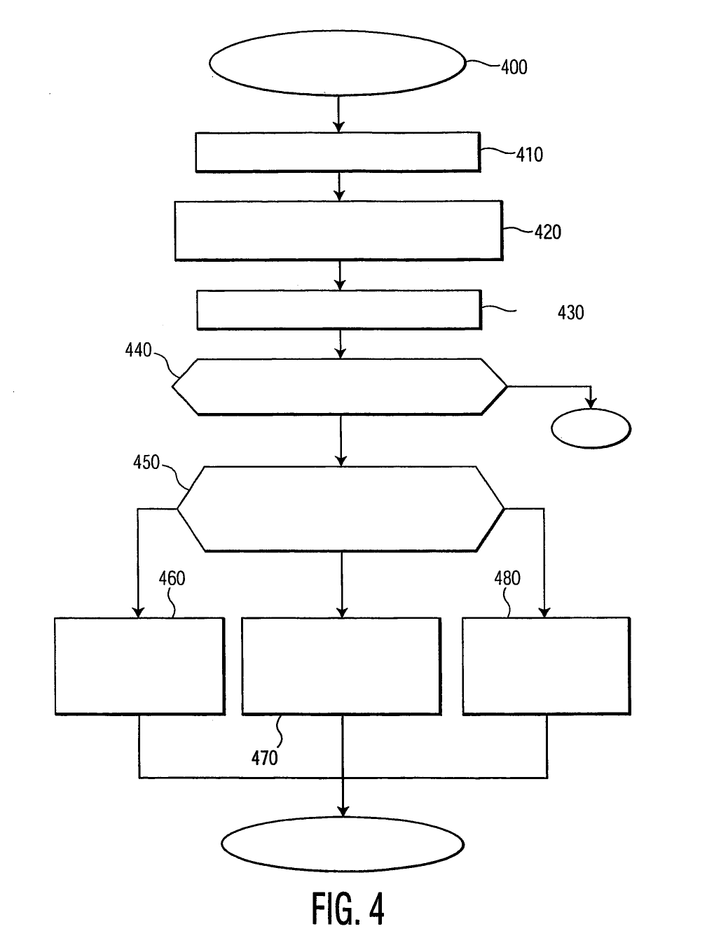

FIG. 4 is a flow chart describing an exemplary object classification process for using the pattern classification system of FIG. 2 for pattern recognition and classification.

The present invention provides an object classification scheme that employs an improved radial basis function network for comparing images acquired under non-uniform illumination conditions. While the exemplary embodiment discussed herein employs Radial Basis Function Networks, it is noted that other neural networks could be similarly employed, such as back propagation networks, multi-layered perceptron-based networks and Bayesian-based neural networks, as would be apparent to a person of ordinary skill in the art. For example, neural networks based on Principle Component Analysis (PCA) or Independent Component Analysis (ICA), or a classifier based on Bayesian techniques or Linear Discriminant Analysis (LDA), could also be employed, as would be apparent to a person of ordinary skill.

FIG. 1 illustrates an exemplary prior art classifier 100 that uses Radial Basis Functions (RBFs). As previously indicated, construction of an RBF neural network used for classification involves three different layers. An input layer is made up of source nodes, referred to herein as input nodes. The second layer is a hidden layer whose function is to cluster the data and, generally, to reduce its dimensionality to a limited degree. The output layer supplies the response of the network to the activation patterns applied to the input layer. The transformation from the input space to the hidden-unit space is non-linear, whereas the transformation from the hidden-unit space to the output space is linear.

Thus, the classifier 100 comprises (1) an input layer comprising input nodes 110 and unit weights 115, which connect the input nodes 110 to hidden nodes 120; (2) a “hidden layer” comprising hidden nodes 120; and (3) an output layer comprising linear weights 125 and output nodes 130. For pattern recognition and classification, a select maximum device 140 and a final output 150 are added.

It is noted that unit weights 115 are such that each connection from an input node 110 to a hidden node 120 essentially remains the same (i.e., each connection is “multiplied” by a one). However, linear weights 125 are such that each connection between a hidden node 120 and an output node 130 is multiplied by a weight. The weight is determined and adjusted during a training phase, as described below in conjunction with FIG. 3.

In the example of FIG. 1, there are five input nodes 110, four hidden nodes 120, and three output nodes 130. However, FIG. 1 is merely exemplary and, in the description given below, there are D input nodes 110, F hidden nodes 120, and M output nodes 130. Each hidden node 120 has a Gaussian pulse nonlinearity specified by a particular mean vector μᵢ and variance vector σᵢ², where i=1, . . . , F and F is the number of hidden nodes 120. Note that σᵢ² represents the diagonal entries of the covariance matrix of Gaussian pulse i. Given a D -dimensional input vector X, each BF node i outputs a scalar value yᵢ, reflecting the activation of the BF caused by that input, as follows:

$${y}_{i} = {φ}_{i} ( ‖ X - {μ}_{i} ‖ ) = exp [ - {\sum }_{k = 1}^{D} \frac{{( {x}_{k} - {μ}_{ik} )}^{2}}{2 h {σ}_{ik}^{2}} ] , \qquad \{ 1 \}$$

where h is a proportionality constant for the variance, xₖ is the k th component of the input vector X=[x₁, x₂, . . . , x_{D}], and μᵢₖ and φᵢₖ are the k th components of the mean and variance vectors, respectively, of basis node i. Inputs that are close to the center of a Gaussian BF result in higher activations, while those that are far away result in lower activations. Since each output node of the RBF classifier 100 forms a linear combination of the hidden node 120 activations, the part of the network 100 connecting the middle and output layers is linear, as shown by the following:

$${z}_{j} = {\sum }_{i} {w}_{ij} {y}_{i} + {w}_{oj} , \qquad \{ 2 \}$$

where zⱼ is the output of the j th output node, yᵢ is the activation of the i th BF node, wᵢⱼ is the weight connecting the i th BF node to the jth output node, and wₒⱼ is the bias or threshold of the j th output node. This bias comes from the weights associated with a hidden node 120 that has a constant unit output regardless of the input.

An unknown vector X is classified as belonging to the class associated with the output node j with the largest output zⱼ, as selected by the select maximum device 140. The select maximum device 140 compares each of the outputs from the M output nodes to determine final output 150. The final output 150 is an indication of the class that has been selected as the class to which the input vector X corresponds. The linear weights 125, which help to associate a class for the input vector X, are learned during training. The weights wᵢⱼ in the linear portion of the classifier 100 are generally not solved using iterative minimization methods such as gradient descent. Instead, they are usually determined quickly and exactly using a matrix pseudoinverse technique. This technique and additional information about RBF classifiers are described, for example, in R. P. Lippmann and K. A. Ng, “Comparative Study of the Practical Characteristic of Neural Networks and Pattern Classifiers,” MIT Technical Report 894, Lincoln Labs. (1991); C. M. Bishop, “Neural Networks for Pattern Recognition,” Ch. 5 (1995); J. Moody & C. J. Darken, “Fast Learning in Networks of Locally Tuned Processing Units”, Neural Computation, vol. 1, 281-94 (1989); or Simon Haykin, “Neural Networks: A Comprehensive Foundation,” Prentice Hall, 256-317 (1999), each incorporated by reference herein.

A detailed algorithmic description of an exemplary radial basis function classifier is discussed below in conjunction with FIGS. 3 and 4. Initially, the size of the RBF network is determined by selecting F, the number of hidden nodes. The appropriate value of F is problem-specific and usually depends on the dimensionality of the problem and the complexity of the decision regions to be formed. In general, F can be determined empirically by trying a variety of F s, or it can set to some constant number, usually larger than the input dimension of the problem.

After F is set, the mean mᵢ and variance σᵢ² vectors of the BFs can be determined using a variety of methods. They can be trained, along with the output weights, using a back-propagation gradient descent technique, but this usually requires a long training time and may lead to suboptimal local minima. Alternatively, the means and variances can be determined before training the output weights. Training of the networks would then involve only determining the weights.

The BF centers and variances are normally chosen so as to cover the space of interest. Different techniques have been suggested. One such technique uses a grid of equally spaced BFs that sample the input space. Another technique uses a clustering algorithm such as K-means to determine the set of BF centers, and others have chosen random vectors from the training set as BF centers, making sure that each class is represented. For a further discussion of RBFNs, see, for example, U.S. patent application Ser. No. 09/794,443, filed Feb. 27, 2001, entitled “Classification of Objects Through Model Ensembles,” incorporated by reference herein.

Generally, each Radial Basis Function classifier 100 will indicate the probability that a given object is a member of the class associated with the corresponding node. For a discussion of the extraction of horizontal, vertical and combined gradients from the input intensity images for use as the feature vectors, see, for example, U.S. patent application Ser. No. 09/794,443, filed Feb. 27, 2001, entitled “Classification of Objects Through Model Ensembles,” incorporated by reference herein. Generally, the process involves processing a collection of sequences of a set of model objects, and extracting horizontal, vertical and combined gradients for each object to form a set of image vectors corresponding to each object.

FIG. 2 is an illustrative pattern classification system 200 using the radial basis function network 100 of FIG. 1, as modified in accordance with the invention. FIG. 2 comprises a pattern classification system 200, shown interacting with input patterns 210 and Digital Versatile Disk (DVD) 250, and producing classifications 240.

Pattern classification system 200 comprises a processor 220 and a memory 230, which itself comprises an RBFN training process 300, discussed below in conjunction with FIG. 3, and an object classification process 400, discussed below in conjunction with FIG. 4. Pattern classification system 200 accepts input patterns and classifies the patterns. For example, the input patterns could be images from a video, and the pattern classification system 200 can be used to distinguish humans from pets.

The pattern classification system 200 may be embodied as any computing device, such as a personal computer or workstation, containing a processor 220, such as a central processing unit (CPU), and memory 230, such as Random Access Memory (RAM) and Read-Only Memory (ROM). In an alternate embodiment, the pattern classification system 200 disclosed herein can be implemented as an application specific integrated circuit (ASIC), for example, as part of a video processing system.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks such as DVD 250, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer readable code means is any mechanism for allowing a computer to read instructions and data, such as magnetic variations on a magnetic media or height variations on the surface of a compact disk, such as DVD 250.

Memory 230 will configure the processor 220 to implement the methods, steps, and functions disclosed herein. The memory 230 could be distributed or local and the processor 220 could be distributed or singular. The memory 230 could be implemented as an electrical, magnetic or optical memory, or any combination of these or other types of storage devices. The term “memory” should be construed broadly enough to encompass any information able to be read from or written to an address in the addressable space accessed by processor 220. With this definition, information on a network is still within memory 250 of the pattern classification system 300 because the processor 220 can retrieve the information from the network.

FIG. 3 is a flow chart describing an exemplary implementation of the RBFN training process 400 of FIG. 2. As is known in the art, training a pattern classification system is generally performed in order for the classifier to be able to categorize patterns into classes. Generally, the RBFN training process 300 is employed to train the Radial Basis Function neural network 100, using image data from an appropriate ground truth data set that contains an indication of the correct object classification. As previously indicated, each of the connections in the Radial Basis Function neural network 100 between the input layer 110 and the pattern (hidden layer) 120 and between the pattern (hidden layer) 120 and the output layer 130 are assigned weights during the training phase.

As shown in FIG. 3, the exemplary RBFN training process 300 initializes the RBF network 100 during step 310. As previously indicated, the initialization process typically involves the following steps:

(a) fixing the network structure by selecting F, the number of basis functions, where each basis function I has the following output:

$${y}_{i} = {φ}_{i} ( ‖ X - {μ}_{i} ‖ ) = exp [ - {\sum }_{k = 1}^{D} \frac{{( {x}_{k} - {μ}_{ik} )}^{2}}{2 h {σ}_{ik}^{2}} ] ,$$

where k is the component index;

(b) determining the basis function means μ_{I}, where I equals 1, . . . , F, using a K-means clustering algorithm;

(c) determining the basis function variances σ_{I}², where I equals 1, . . . , F (the basis function variances σ_{I}² can be fixed to some global value or set to reflect the density of the data vectors in the vicinity of the BF center); and

(d) determining H, a global proportionality factor for the basis function variances by empirical search to allow for resealing of the BF widths (by searching the space of H for values that result in good performance, its proper value is determined).

After the BF parameters are set, the next step is to train the output weights. Thus, the exemplary RBFN training process 300 presents the training image data to the initialized RBF network 100 during step 320. In one embodiment, the training image presentation process typically involves the following steps:

(a) inputting training patterns X(p) and their class labels C(p) to the classifier, where the pattern index is p equals 1, . . . , N;

(b) computing the output of the basis function nodes y_{I}(p), where I equals 1, . . . , F, resulting from pattern X(p);

(c) computing the F×F correlation matrix R of the basis function outputs, as follows:
Ril=Σₚyi(p)yl(p)

(d) computing the F×M output matrix B, where dⱼ is the desired output and M is the number of output classes, as follows:

$${B}_{lj} = {\sum }_{p} {y}_{l} ( p ) {d}_{j} ( p ) , where {d}_{j} ( p ) = \{ \begin{matrix}1 & if C ( p ) = j \\ 0 & otherwise\end{matrix} ,$$

and j=1, . . . , M.

It is noted that each training pattern produces one R and one B matrix. The final R and B matrices are the result of the sum of N individual R and B matrices, where N is the total number of training patterns. Once all N patterns have been presented to the classifier, the output weights wᵢⱼ can be determined.

Thus, the exemplary RBFN training process 300 determines the output weights wᵢⱼ for the RBF network 100 during step 330. In one embodiment, the weights for the initialized RBF network 100 are calculated as follows:

(a) inverting the final F×F correlation matrix R to get R⁻¹; and

(b) solving for the weights in the network using the following equation:
w*ij=Σₗ(R⁻¹)lBlj
Thereafter, program control of the RBFN training process 300 terminates.

For a further discussion of training techniques for Radial Basis Function classifiers 100, see, for example, U.S. patent application Ser. No. 09/794,443, filed Feb. 27, 2001, entitled “Classification of Objects Through Model Ensembles,” incorporated by reference herein.

FIG. 4 is a flow chart describing an exemplary object classification process 400 incorporating features of the present invention. As shown in FIG. 4, the exemplary object classification process 400 begins in step 410, when an unknown pattern, Xₜₑₛₜ, is presented or obtained. It is noted that the image, Xₜₑₛₜ, can be preprocessed to filter out unintended moving objects from detected moving objects, for example, according to a detected speed and aspect ratio of each detected moving object, in a known manner.

During step 420, the input pattern, Xₜₑₛₜ, is applied to the Radial Basis Function classifier 100 to compute the classification value. Thereafter, the input pattern, Xₜₑₛₜ, is classified by the RBF network 100 during step 430 using conventional techniques. In one implementation the input pattern, Xₜₑₛₜ, is classified as follows:

(a) computing the basis function outputs, for all F basis functions, as follows:
yᵢ=Φ(∥Xₜₑₛₜ−μᵢ∥)

(b) computing output node activations, as follows:

$${z}_{j} = {\sum }_{i} {w}_{ij} {y}_{i} + {w}_{oj}$$

(c) selecting the output zⱼ with the largest value and classify Xₜₑₛₜ as the class j.

The RBF input generally consists of n size normalized face images fed to the network 100 as 1D vectors. The hidden (unsupervised) layer, implements an enhanced k-means clustering procedure, where both the number of Gaussian cluster nodes and their variances are dynamically set. The number of clusters varies, in steps of 5, from ⅕ of the number of training images to n, the total number of training images. The width of the Gaussian for each cluster, is set to the maximum (the distance between the center of the cluster and the farthest away member; within class diameter, the distance between the center of the cluster and closest pattern from all other clusters) multiplied by an overlap factor o, here equal to 2. The width is further dynamically refined using different proportionality constants h. The hidden layer yields the equivalent of a functional face base, where each cluster node encodes some common characteristics across the face space. The output (supervised) layer maps face encodings (“expansions”) along such a space to their corresponding ID classes and finds the corresponding expansion (“weight”) coefficients using pseudoinverse techniques. It is noted that the number of clusters is frozen for that configuration (the number of clusters and specific proportionality constant h) which yields 100% accuracy on ID classification when tested on the same training images.

According to one feature of the present invention, test is performed during step 440 to determine if the classification value assigned to the input pattern during step 430 is below a predefined, configurable threshold. If it is determined during step 430 that the classification value is not below the threshold, then program control terminates. If, however, it is determined during step 430 that the classification value is below the threshold, then further processing is performed during steps 450 through 480 to determine if the poor classification value is due to non-uniform illumination.

Thus, the input pattern, Xₜₑₛₜ, and the image associated with the hidden node to which X_{Test} was classified are evaluated during step 450 to determine if they have uniform illumination. For example, to ascertain if an image is uniform, the intensity values are normalized to lie between 0 and 1. Thereafter, the image is divided into a number of regions and the mean and the variance are computed. If the mean and variance are within a range between any two regions, then the image is said to be uniform.

If it is determined during step 450 that the test image and the hidden node to which the classifier assigned the test image are both uniform, then the image is accepted during step 460 and the probability is set to a value above the user specified threshold.

If it is determined during step 450 that the test image is uniform and the hidden node is not uniform (or vice versa), then the image is not accepted during step 470 and the classification value is kept as the same value as assigned by the classifier 100.

Finally, if it is determined during step 450 that both the test image and the hidden node are not uniform, then the normalized cross correlation (NCC) measure is used during step 480 and the classification value is set as the NCC value. The equation for NCC is expressed as follows:

$$NCC = \frac{\sum ( {x}_{i} - \overline{x} ) \cdot ( {r}_{i} - \overline{r} )}{\sqrt{\sum {( {x}_{i} - \overline{x} )}^{2} \cdot \sum {( {r}_{i} - \overline{r} )}^{2}}}$$

where x is the test image and r is the hidden node. NCC is usually performed by dividing the test and the hidden node into a number of sub regions and then summing the computation on each one of the regions. Generally, the NCC will smooth the images by matching segments within each image and determining how far each segment is from a mean. Thereafter, the deviation from mean values for each segment are averaged.

In a further variation, the network 100 is trained in accordance with FIG. 3. Thereafter, for each test image, a Eucliedian distance metric is computed. For whichever node the distance is minimum, the image associated with the minimum node and the test image are processed using only steps 450 through 480 of FIG. 4.

It is to be understood that-the embodiments and variations shown and described herein are merely illustrative of the principles of this invention and that various modifications may be implemented by those skilled in the art without departing from the scope and spirit of the invention.

1. A method for classifying an object in image data, comprising the steps of: assigning said image data to a node in a neural network, said node having an associated node image; and
applying a normalized cross correlation measure to compare said image data and said node image if said image data and said node image are obtained under non-uniform illumination.

2. The method of claim 1, wherein a classification value for said object is determined by said normalized cross correlation measure.

3. The method of claim 1, wherein a determination of whether an image is obtained under non-uniform illumination further comprises the steps of normalizing intensity values in said image, dividing said image into a number of regions, computing the mean and the variance of said regions and determining if said image is uniform based on said mean and variance values.

4. The method of claim 1, wherein said classification value associated with said node is assigned to said image data if both of said image data and said node image are obtained under uniform illumination.

5. The method of claim 1, wherein said node image is not accepted if only one of said image data and said node image are obtained under uniform illumination.

6. The method of claim 1, wherein said applying step is only performed if said classification value does not satisfy a predefined threshold.

7. The method of claim 1, wherein said node has an associated class label identifying a class to which the object corresponds to and a classification value indicating the probability with which the object belongs to the class.

8. The method of claim 1, further comprising the step of outputting a class label based upon said normalized cross correlation measure.

9. The method of claim 1, wherein said neural network is a radial basis function network.

10. The method of claim 1, wherein said neural network is a back propagation network.

11. The method of claim 1, wherein said neural network is a multi-layered perceptron-based network.

12. The method of claim 1, wherein said neural network is a Bayesian-based neural network.

13. An apparatus for classifying an object in image data, comprising:
a memory; and
at least one processor, coupled to the memory, operative to:
assign said image data to a node in a neural network, said node having an associated node image; and
apply a normalized cross correlation measure to compare said image data and said node image if said image data and said node image are obtained under non-uniform illumination.

14. The apparatus of claim 13, wherein a classification value for said object is determined by said normalized cross correlation measure.

15. The apparatus of claim 13, wherein said processor is further configured to determine whether an image is obtained under non-uniform illumination by normalizing intensity values in said image, dividing said image into a number of regions, computing the mean and the variance of said regions and determining if said image is uniform based on said mean and variance values.

16. The apparatus of claim 13, wherein said classification value associated with said node is assigned to said image data if both of said image data and said node image are obtained under uniform illumination.

17. The apparatus of claim 13, wherein said node image is not accepted if only one of said image data and said node image are obtained under uniform illumination.

18. The apparatus of claim 13, wherein said node has an associated class label identifying a class to which the object corresponds to and a classification value indicating the probability with which the object belongs to the class.

19. The apparatus of claim 13, wherein said neural network is a radial basis function network.

20. The apparatus of claim 13, wherein said neural network is a back propagation network.

21. The apparatus of claim 13, wherein said neural network is a multi-layered perceptron-based network.

22. The apparatus of claim 13, wherein said neural network is a Bayesian-based neural network.

23. An article of manufacture for classifying an object in image data, comprising:
a machine readable medium containing one or more programs which when executed implement the steps of:
assigning said image data to a node in a neural network, said node having an associated node image; and
applying a normalized cross correlation measure to compare said image data and said node image if said image data and said node image are obtained under non-uniform illumination.
